(19) United States
(12) Patent Application Publication
(10) Pub. No.: US 2020/0217994 A1
(43) Pub. Date: Jul. 9, 2020

(54) LENS, MANUFACTURIGN METHOD THEREOF, AND CAMERA LENS

(71) Applicant: AAC Technologies Pte. Ltd., Singapore city (SG)

(72) Inventor: Jia Wang, Shenzhen (CN)

(21) Appl. No.: 16/729,484

(22) Filed: Dec. 30, 2019

(30) Foreign Application Priority Data
Jan. 4, 2019 (CN) 201910008250.2

(51) Int. Cl. G02B 3/04; G02B 5/00; G02B 1/115

(52) U.S. Cl. CPC G02B 3/04; G02B 1/115; G02B 5/003

(57) ABSTRACT

The present disclosure provides a lens, a manufacturing method thereof, and a camera lens. The lens includes an optical portion for imaging and a fixing portion provided on an outer periphery of the optical portion, and a black matting film for matting is provided on an outer surface of the fixing portion. In the present disclosure, by providing the black matting film for matting on the outer surface of the fixing portion, i.e., by performing matting treatment on the lens, the fixing portion of the lens no longer reflects light. In this way, the lens have an improved matting effect, and thus the stray light can be avoided during the use of the camera lens containing the lens.

### CROSS-REFERENCE TO RELATED APPLICATIONS

The present disclosure claims priority to Chinese Patent Application No. 201910008250.2, filed on Jan. 4, 2019, the content of which is incorporated herein by reference in its entirety.

### TECHNICAL FIELD

The present disclosure relates to the field of optical imaging technology, and particularly to a lens, a manufacturing method of the lens, and a camera lens.

### BACKGROUND

In recent years, with the development of mobile phone technology and the rise of electronic devices with camera functions, camera lenses have been widely used in various products. The volume of the camera lenses tends to be miniaturized, in order to meet the current trend of producing smaller and smaller electronic devices.

The camera lens in the existing electronic devices includes a lens barrel and a plurality of lenses stacked in the lens barrel. Each lens in the camera lens is required to be subjected to a matting treatment, so as to avoid stray light during use of the mounted camera lens. The lenses are usually treated with laser matting, but such laser-treated lenses have such a poor matting effect that the assembled camera lens still has stray light.

In view of the above, it is necessary to develop a lens with a new structure.

### SUMMARY

The present disclosure provides a lens, a manufacturing method of the lens, and a camera lens, in order to solve the problem of stray light still present in the camera lens after laser matting treatment is performed on the lenses in the camera lens in the related art.

In order to achieve the object, the present disclosure provides a lens, comprising: an optical portion for imaging; and a fixing portion provided on an outer periphery of the optical portion, wherein a black matting film for matting is provided on an outer surface of the fixing portion.

As an improvement, the outer surface of the fixing portion comprises a top wall surface, a bottom wall surface, and a side wall surface connected between the top wall surface and the bottom wall surface; and wherein the black matting film is provided on the top wall surface, the side wall surface, and the bottom wall surface.

As an improvement, the black matting film is a single-layered absorption film or a multilayered antireflection film.

As an improvement, the single-layered absorption film is made of a composition of silicon dioxide and chromium.

As an improvement, the multilayered antireflection film comprises a high refractive index material layer and a low refractive index material layer, wherein the low refractive index material layer is disposed between the high refractive index material layer and the fixing portion and has a lower refractive index than the high refractive index material layer; or, the multilayered antireflection film comprises a high refractive index material layer, a low refractive index material layer disposed between the high refractive index material layer and the fixing portion, and a high absorption coefficient material mixed in at least one of the high refractive index material layer or the low refractive index material layer.

As an improvement, the high refractive index material layer is made of at least one of titanium nitride, titanium dioxide, or tantalum dioxide; the low refractive index material layer is made of at least one of silicon dioxide, magnesium fluoride, or a composition of silicon dioxide and aluminum oxide; and the high absorption coefficient material is made of at least one of a composition of silicon dioxide and chromium, a composition of silicon dioxide, aluminum oxide and chromium, or titanium nitride.

As an improvement, the multilayered antireflection film comprises at least two high refractive index material layers and at least two low refractive index material layers, the multilayered antireflection film is arranged by sequentially alternating and stacking the at least two low refractive index material layers and the at least two high refractive index material layers in a direction facing away from the fixing portion from the outer surface of the fixing portion.

As an improvement, the at least two high refractive index material layers are made of titanium dioxide, and the at least two low refractive index material layers are made of a composition of silicon dioxide and chromium.

As an improvement, the at least two high refractive index material layers are made of titanium nitride, and the at least two low refractive index material layers are made of silicon dioxide.

As an improvement, a sum of a number of the at least two high refractive index material layers and a number of the at least two low refractive index material layers is an even number.

The present disclosure further provides a camera lens, comprising at least one lens as described above.

The present disclosure further provides a manufacturing method of the lens as described above, the manufacturing method comprising: placing a lens blank on a workpiece tray of a film depositing machine; evacuating the film depositing machine, and heating the workpiece tray; and depositing a black matting film on an outer surface of a fixing portion of the lens blank to form the lens

As an improvement, said depositing the black matting film starts when the film depositing machine is evacuated to 1.0-4.0E-3 Pa, and the workpiece tray is heated to 50-150 degrees Celsius.

As an improvement, said depositing the black matting film starts when the film depositing machine is evacuated to 2.0E-3 Pa, and the workpiece tray is heated to 65-90 degrees Celsius.

As an improvement, the black matting film is a multilayered antireflection film, and said depositing the black matting film comprises: sequentially alternating and depositing low refractive index material layers and high refractive index material layers on the outer surface of the fixing portion of the lens blank; and the low refractive index material layers and the high refractive index material layers are deposited under oxygen, and a depositing rate of the high refractive index material layers is 3-4 A/s, and a depositing rate of the low refractive index material layers is 4-6 A/s

The beneficial effects of the present invention include: by providing a black matting film for matting on the outer surface of the fixing portion, a matting treatment is performed on the lens, so that the fixing portion of the lens no longer reflects light, thereby improving the matting effect of the lens and avoiding stray light during the use of the lens.

### BRIEF DESCRIPTION OF DRAWINGS

FIG. 1 is a structural schematic diagram of a lens according to Embodiment 1 of the present disclosure;

FIG. 2 is a partially enlarged view of part A in FIG. 1;

FIG. 3 is a structural schematic diagram of a camera lens according to Embodiment 1 of the present disclosure;

FIG. 4 is a flowchart of a manufacturing method of the lens according to Embodiment 1 of the present disclosure;

FIG. 5 is a structural schematic diagram of a lens deposited with a multilayered antireflection film according to Embodiment 2 of the present disclosure; and

FIG. 6 is a partially enlarged view of part B in FIG. 5.

In the drawings:
1 lens;
10 optical portion;
20 fixing portion;
21 top wall surface;
22 bottom wall surface;
23 side wall surface;
30 black matting film;
31 single-layered absorption film;
32 multilayered antireflection film;
321 high refractive index material layer;
322 low refractive index material layer;
40 lens barrel;
50 light shielding plate;
60 compression ring.

### DESCRIPTION OF EMBODIMENTS

The present disclosure is described in detail below with reference to the drawings.

### Embodiment 1

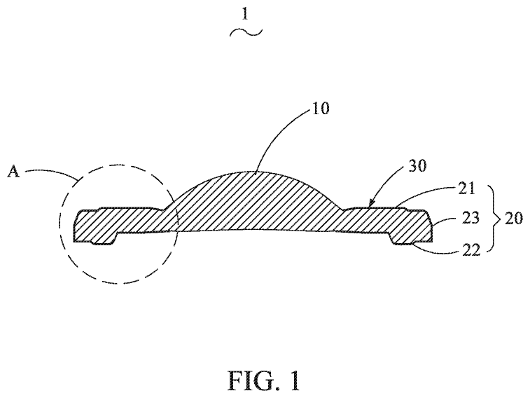

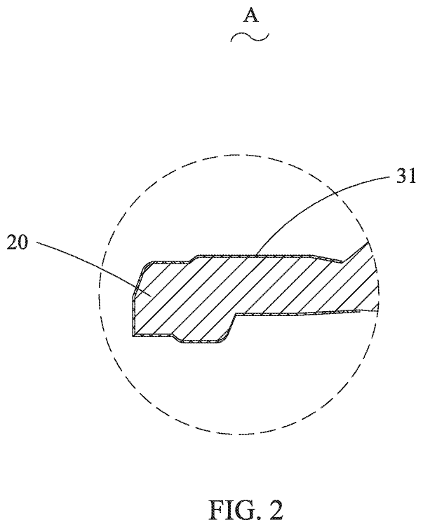

As shown in FIG. 1 and FIG. 2, Embodiment 1 of the present disclosure provides a lens 1, and the lens 1 includes an optical portion 10 having a circular edge and a fixing portion 20 provided on an outer periphery of the optical portion 10. In the present embodiment, an outer circumferential contour of the lens 1 has a round shape or a square shape. The optical portion 10 of the lens 1 is used for imaging of the lens 1, and the fixing portion 20 is used to hold the lens 1 against an inner wall of a lens barrel 40 of a camera lens. Therefore, in this embodiment, a black matting film 30 for matting is provided on an outer surface of the fixing portion 20, i.e., a matting treatment is performed on the lens 1, such that the fixing portion 20 of the lens 1 no longer reflects light, and the fixing portion 20 does not produce stray light during the use of the camera lens, thereby effectively improving the imaging quality of the camera lens.

For example, the outer surface of the fixing portion 20 includes a top wall surface 21, a bottom wall surface 22, and a side wall surface 23 connected between the top wall surface 21 and the bottom wall surface 22, and the black matting film 30 is provided on all of the top wall surface 21, the side wall surface 23, and the bottom wall surface 22. In this way, a matting treatment is performed on the lens, and the fixing portion 20 of the lens 1 no longer reflects light.

In the present embodiment, for example, the black matting film 30 is a single-layered absorption film 31, and the single-layered absorption film 31 is made of a composition of silicon dioxide (SiO₂) and chromium (Cr). The black matting film 30 can perform deep matting on the lens 1. In a manufacturing process of the lens 1, the black matting film 30 can be formed on the fixing portion 20 of the lens 1 by using a depositing or coating process. In this invention, the black matting film 30 is plated on the fixing portion 20 of the lens 1, which increases the adhesion between the black matting film 30 and the fixing portion 20 and prevents the black matting film 30 from detaching from the fixing portion 20 of the lens 1.

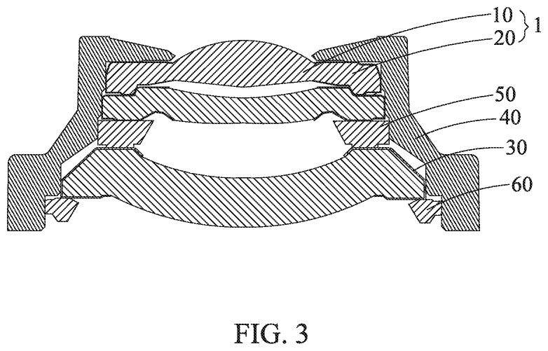

Further referring to FIG. 3, the present embodiment also provides a camera lens. The camera lens includes a plurality of lenses 1 stacked and connected in sequence. It can be understood that the number of the lenses 1 may be set according to actual needs. For example, the number of the lenses 1 can be two, three, four, or more.

In the present embodiment, the camera lens further includes a lens barrel 40. The plurality of lenses 1 is stacked and amounted in the lens barrel 40. The lens barrel 40 is generally circular, i.e., an inner wall surface for supporting and receiving the lenses 1 is preferably a cylindrical surface. Ends of the lenses 1 abut against the inner wall surface of the lens barrel 40. It is also possible in specific applications that the camera lens has a structure without the lens barrel 40. If the camera lens has no lens barrel 40, fixing between every two adjacent lenses 1 can be implemented by bonding and stacking with an adhesive.

The camera lens further includes a light shielding plate 50. The light shielding plate 50 is located between two lenses 1. The light shielding plate 50 is used to absorb stray light generated between the two lenses 1 to improve the imaging quality of the camera lens, as well as to adjust a distance between the two lenses 1. Moreover, it can be also used to prevent light on a previous lens 1 from irradiating the fixing portion 20 of a next lens 1 to generate stray light.

For example, the camera lens further includes a compression ring 60 disposed in the lens barrel 40. In the present embodiment, the lenses 1 are fixed in the lens barrel 40 through the pressure ring 60, so that the camera lens can be easily disassembled.

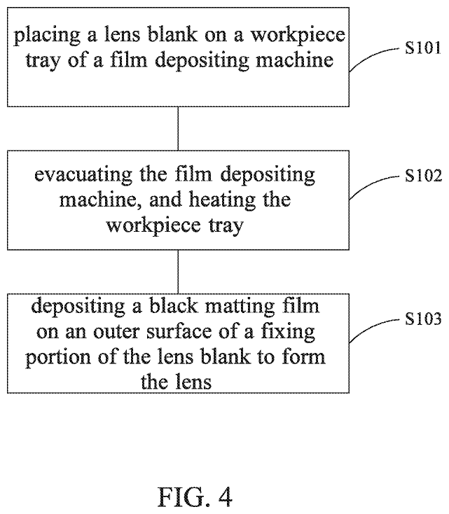

As shown in FIG. 4, Embodiment 1 of the present disclosure further provides a manufacturing method of the lens 1. The method includes steps S101 to S103.

S101: placing a lens blank on a depositing position of a film depositing machine, e.g., on a workpiece tray;

S102: evacuating the film depositing machine to reach an initial vacuum of 1.0-4.0E-3 Pa, and then heating the workpiece tray to 50-150 degrees Celsius to be ready for film deposition; and

S103: vapor-depositing a single layer or multiple layers of film material so as to form a black matting film 30 on an outer surface of a portion of the lens blank which forms the fixing portion 20 of the lens, so as to form the lens. Different gases may be introduced in due time according to different heating methods and material characteristics, and it is determined through light control/crystal control that a thickness of the deposited film reaches a design standard.

For example, said depositing the black matting film 30 starts when the film depositing machine is evacuated to 2.0E-3 Pa, and the workpiece tray is heated to 65-90 degrees Celsius.

### Embodiment 2

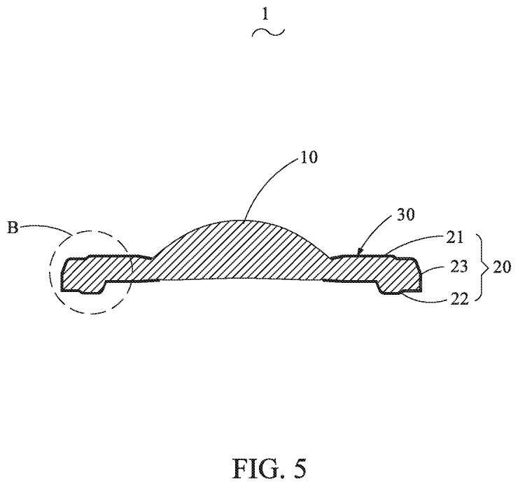

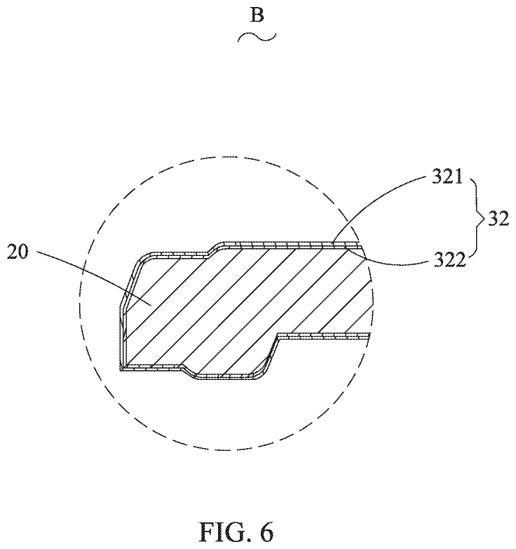

As shown in FIG. 5 and FIG. 6, the lens 1 provided in Embodiment 1 differs from the lens 1 provided in the Embodiment 1 in the arrangement of the black matting film 30. Specifically, in the present embodiment, the black matting film 30 is a multilayered antireflection film 32. The multilayered antireflection film 32 may have two different structures. The first structure is configured that the multilayered antireflection film 32 includes a high refractive index material layer 321, and a low refractive index material layer 322 that is disposed between the high refractive index material layer 321 and the fixing portion 20 and has a lower refractive index than the high refractive index material layer 321. The second structure is configured that the multilayered antireflection film 32 includes a high refractive index material layer 321, a low refractive index material layer 322 that is disposed between the high refractive index material layer 321 and the fixing portion 20, and a high absorption coefficient material mixed in the high refractive index material layer 321 and/or the low refractive index material layer 322. The multilayered antireflection film 32 is the common antireflection film added with the high absorption coefficient material. The above-mentioned high refractive index material layer 321 is made of at least one of titanium nitride (TiN), titanium dioxide (TiO₂), or tantalum dioxide (TaO₂). The low refractive index material layer 322 is made of at least one of silicon dioxide (SiO₂), magnesium fluoride (MgF), or a composition of silicon dioxide and aluminum oxide (SiO₂/Al₂O₃). The high absorption coefficient material is made of at least one of a composition of silicon dioxide and chromium (SiO₂/Cr), a composition of silicon dioxide, aluminum oxide and chromium (SiO₂/Al₂O₃/Cr), or titanium nitride (TiN). In the high absorption coefficient material, silicon dioxide needs be used as a base material due to the high absorption characteristic of titanium nitride itself.

In this way, the multilayered antireflection film 32 can a combination of: titanium nitride (TiN)+a composition of silicon dioxide and chromium (SiO₂/Cr), titanium dioxide (TiO₂)+a composition of silicon dioxide and chromium (SiO₂/Cr), tantalum oxide (TiO₂)+a composition of silicon dioxide and chromium (SiO₂/Cr), titanium nitride (TiN)+silicon dioxide (SiO₂), titanium nitride (TiN)+magnesium fluoride (MgF), titanium nitride (TiN)+a composition of silicon dioxide and aluminum oxide (SiO₂/Al₂O₃), titanium nitride (TiN)+a composition of silicon dioxide, aluminum oxide and chromium (SiO₂/Al₂O₃/Cr), titanium dioxide (TiO₂)+a composition of silicon dioxide, aluminum oxide and chromium (SiO₂/Al₂O₃/Cr), or titanium dioxide (TiO₂)+a composition of silicon dioxide, aluminum oxide and chromium (SiO₂/Al₂O₃/Cr).

For example, at least two high refractive index material layers 321 and at least two low refractive index material layers 322 are provided, and a sum of the number of the high refractive index material layers 321 and the number of the low refractive index material layers 322 is an even number. The multilayered antireflection film 32 is arranged by sequentially alternating and stacking the low refractive index material layers 322 and the high refractive index material layers 321 in a direction facing away from the fixing portion 20 from the outer surface of the fixing portion 20.

The manufacturing method of the lenses 1 provided in Embodiment 2 differs from the manufacturing method of the lenses 1 provided in Embodiment 1 in that: said depositing the black matting film 30 includes sequentially alternating and depositing the low refractive index material layers 322 and the high refractive index material layers 321 on the outer surface of the fixing portion 20 of the lens blank. Said depositing the low refractive index material layers 322 and the high refractive index material layers 321 are performed under oxygen, and a depositing rate of the high refractive index material layers 321 is 3-4 A/s, and a depositing rate of the low refractive index material layers 322 is 4-6 A/s. In this way, a black multilayered antireflection film 32 is obtained.

The above is preferred embodiments of the present disclosure. It should be understood that, any modifications made by those skilled in the related art without departing away from the invention concept of the present application shall fall within the protection scope of the present disclosure.

What is claimed is:

1. A lens, comprising:
an optical portion for imaging; and
a fixing portion provided on an outer periphery of the optical portion,
wherein a black matting film for matting is provided on an outer surface of the fixing portion.

2. The lens as described in claim 1, wherein the outer surface of the fixing portion comprises a top wall surface, a bottom wall surface, and a side wall surface connected between the top wall surface and the bottom wall surface; and
wherein the black matting film is provided on the top wall surface, the side wall surface, and the bottom wall surface.

3. The lens as described in claim 1, wherein the black matting film is a single-layered absorption film or a multilayered antireflection film.

4. The lens as described in claim 3, wherein the single-layered absorption film is made of a composition of silicon dioxide and chromium.

5. The lens as described in claim 3, wherein the multilayered antireflection film comprises a high refractive index material layer and a low refractive index material layer, wherein the low refractive index material layer is disposed between the high refractive index material layer and the fixing portion and has a lower refractive index than the high refractive index material layer; or
the multilayered antireflection film comprises a high refractive index material layer, a low refractive index material layer disposed between the high refractive index material layer and the fixing portion, and a high absorption coefficient material mixed in at least one of the high refractive index material layer or the low refractive index material layer.

6. The lens as described in claim 5, wherein the high refractive index material layer is made of at least one of titanium nitride, titanium dioxide, or tantalum dioxide;
wherein the low refractive index material layer is made of at least one of silicon dioxide, magnesium fluoride, or a composition of silicon dioxide and aluminum oxide; and
wherein the high absorption coefficient material is made of at least one of a composition of silicon dioxide and chromium, a composition of silicon dioxide, aluminum oxide and chromium, or titanium nitride.

7. The lens as described in claim 5, wherein the multilayered antireflection film comprises at least two high refractive index material layers and at least two low refractive index material layers, the multilayered antireflection film is arranged by sequentially alternating and stacking the at least two low refractive index material layers and the at least two high refractive index material layers in a direction facing away from the fixing portion from the outer surface of the fixing portion.

8. The lens as described in claim 7, wherein the at least two high refractive index material layers are made of titanium dioxide, and the at least two low refractive index material layers are made of a composition of silicon dioxide and chromium.

9. The lens as described in claim 7, wherein the at least two high refractive index material layers are made of titanium nitride, and the at least two low refractive index material layers are made of silicon dioxide.

10. The lens as described in claim 7, wherein a sum of a number of the at least two high refractive index material layers and a number of the at least two low refractive index material layers is an even number.

11. A camera lens, comprising at least one lens, wherein each of the at least one lens comprises:
an optical portion for imaging; and
a fixing portion provided on an outer periphery of the optical portion,
wherein a black matting film for matting is provided on an outer surface of the fixing portion.

12. A manufacturing method of the lens according to claim 1, the manufacturing method comprising:
placing a lens blank on a workpiece tray of a film depositing machine;
evacuating the film depositing machine, and heating the workpiece tray; and
depositing a black matting film on an outer surface of a portion of the lens blank which forms the fixing portion of the lens, so as to form the lens.

13. The manufacturing method as described in claim 12, wherein said depositing the black matting film starts when the film depositing machine is evacuated to 1.0-4.0E-3 Pa, and the workpiece tray is heated to 50-150 degrees Celsius.

14. The manufacturing method as described in claim 13, wherein said depositing the black matting film starts when the film depositing machine is evacuated to 2.0E-3 Pa, and the workpiece tray is heated to 65-90 degrees Celsius.

15. The manufacturing method as described in claim 14, wherein the black matting film is a multilayered antireflection film, and said depositing the black matting film comprises: sequentially alternating and depositing low refractive index material layers and high refractive index material layers on the outer surface of the fixing portion of the lens blank, and
wherein the low refractive index material layers and the high refractive index material layers are deposited under oxygen, and a depositing rate of the high refractive index material layers is 3-4 A/s, and a depositing rate of the low refractive index material layers is 4-6 A/s.
